(19) United States
(12) Patent Application Publication
(10) Pub. No.: US 2011/0304520 A1
(43) Pub. Date: Dec. 15, 2011

(54) Method of Manufacturing and Operating an Antenna Arrangement for a Communication Device

(75) Inventors: Miomir B. Djordjevic, Wheeling, IL (US); William H. Meitzler, Elk Grove Village, IL (US); Ignatius Gerardus T. de Wilde, Rotterdam (NL); Paul R. Jelonek, Geneva, IL (US); Tun-Jen Chu, Plainfield, IL (US)

(73) Assignee: ILLINOIS TOOL WORKS INC., Glenview, IL (US)

(21) Appl. No.: 13/104,504

(22) Filed: May 10, 2011

Related U.S. Application Data
(60) Provisional application No. 61/353,865, filed on Jun. 11, 2010.

(51) Int. Cl. H01Q 1/38; H01P 11/00; H01Q 21/28

(52) U.S. Cl. 343/893; 343/700 MS; 29/600

(57) ABSTRACT

Thin, flexible antenna arrangements for use in communication devices, such as mobile communications devices, and methods of making and using the antenna arrangements are provided. The methods used to make the antenna arrangements are print-based and provide a simplified procedure, with a reduced number of process steps, the use of fewer materials and the production of less material waste than conventional methods based on etching and die cutting.

### FIELD OF THE INVENTION

The present invention relates to the field of electronic communication devices, and more particularly, to antennas for mobile communication devices and antennas for WLAN, FM, AWS, WiMax, LTE, Bluetooth, UHF, VHF, Media FLO, Land Mobile, Cognitive Radio, Wireless Microphone, PCS, GSM, ZigBee, CDMA, iDEN, UWB, Amateur Radio, Point-to-Point, Television, radar, satellite, and radio frequency communication between different pieces of equipment, including, but not limited to, medical equipment and patient monitoring devices, office equipment, electronic meeting communication devices, entertainment devices, manufacturing machinery, automobile functions, monitoring devices, home and restaurant appliances, electric and gas distribution and metering devices, gambling machinery and equipment, and livestock monitoring devices.

### BACKGROUND OF THE INVENTION

The use of mobile electronic communication devices has increased dramatically. As a result, mobile devices such as cellular telephones, portable and pocket computers, electronic book readers (e-readers), portable internet-enabled measuring instruments, internet-enabled security cameras and WLAN-enabled medical monitoring devices, have substantially increased in functionality. In addition to providing the traditional primary functions, such as placing a telephone call, these devices are now available with an array of secondary functions. Mobile devices, besides a specific frequency for a single primary function, typically utilize a narrow band at a distinctly different frequency range, although with the emergence of secondary functions, mobile devices must now rely on several active radio frequency bands, often simultaneously, over a very broad range of radio frequencies for their full range of communications. Cellular telephones are the best example of the proliferation of radio frequency communications, but are only one of many already existing and possible future applications.

A cellular telephone, for example, primarily uses microwave antennas to send and receive radio signals to/from cell site base stations. These primary antennas are continually evolving as more bandwidth is needed and more systems are developed. In the past several years, in addition to their principal function of communication between the hand-held device and a ‘cell’ tower, cellular telephones have developed a number of secondary functions that all rely on multiple radio frequency communications over a broad range of radio frequencies. Certain cellular telephones have only one secondary antenna, a receiving FM antenna, to allow them to function as FM radios. Other cellular telephones are multifunctional, having a main communication function (i.e., cellular antenna) and a number of different secondary antennas in subsets, one subset including, for example, an FM transmitter antenna (for the transmission of music to a car radio at FM frequency) and a wireless LAN (WLAN) antenna, and another subset including a Bluetooth antenna and a GPS locator antenna. Still another subset would include mobile television (Media FLO and DVB-H) antennas. All of the aforementioned secondary functions are served by antennas designed for a specific purpose and commonly built as a “secondary” set of antennas, separated from the principal antenna which is used for cellular telephone communications. A secondary antenna arrangement for a mobile electronic communication device can include, for example, one or more special-function high-frequency range antennas, a transmitting or receiving loop Frequency Modulation (FM) antenna, etc.

Antenna arrangements are typically manufactured using solid or flexible printed circuit boards (FR4 or FPCBs) or die-cut metal foil. Each of these methods of manufacturing utilizes a stock piece of metal foil attached to a dielectric substrate, and the metal foil is either chemically etched or cut away to form one or more conductive traces for the antenna arrangement. In the case of FPCBs, the metal foil is typically subjected to etching and plating baths that generate substantial chemical waste. The metal foil that is chemically etched away cannot be recovered and therefore generates a substantial waste of expensive raw materials. Producing antennas by a die-cut metal foil process does not involve chemical processing and is more environmentally friendly. However, with this technology, substantial portions of the expensive adhesive pre-coated metal foil are cut away to form the conductors for the antenna, resulting in excess waste of adhesive-coated metal foil that cannot be re-used or recovered.

Another manufacturing technique is bending (forming in 3D shapes) metal strips and staking the strips to a housing. Such methods require very tight antenna cutting and bending tolerances, and very tight phone case tolerances. Bent (formed) antennas are easily bent in shipping and in final assembly.

It would be advantageous to provide an improved method of manufacturing primary and secondary antennas for different mobile electronic communication devices, which will help to address, at least in part, one or more of the aforementioned shortcomings.

In addition, manufacturing antennas by die-cutting metal foil has reached limitations in cutting intricate small dimensions and sharp angle patterns, such that with the new technological advancements, the effort expended on the quality control and amount of defective products have shown an upward trend.

It would be advantageous to provide an alternative to die-cutting metal foil that will not have inherent limitations for manufacturing antennas having small dimensions and various angled patterns.

### SUMMARY OF THE INVENTION

In embodiments of the invention, an antenna arrangement is provided that includes a flexible substrate comprising a dielectric substrate, an array of electrically conductive elements on the surface of that dielectric substrate that forms a simple design or an array of complex geometrical designs functioning as primary or secondary antenna(s), which are encapsulated by a different, but compatible and preferably moisture impermeable, dielectric material formed (e.g., deposited) over and conforming to the conductive antenna designs on the substrate. In some preferred embodiments, the antenna arrangement is free of any additional layers of electrically conductive material formed over the encapsulating dielectric material.

The simple or complex antenna design, depending on the selection of the radio frequencies it serves, includes at least one, and in some embodiments two or more, geometric designs with precisely designed geometric forms, including lengths and widths of certain sections of conductive traces, curvatures or other nonlinear forms of the conductive trace. Each simple or complex antenna design has one set of connecting point(s) or contact(s) for connecting the conductive trace of the antenna design to the electronics of the functional electronic device.

In an embodiment of a simple antenna design, a single conductive trace having a calculated length and width is formed from an electrically conductive material as a single-band antenna functional for receiving and/or transmitting a single frequency band, with at least one electric contact point on the trace.

In an embodiment of a complex antenna design, a multifunctional or multiband antenna can be formed by a single conductive trace that is a complex array of lines and geometric shapes. Multiband antennas utilize multiple modes (single-ended, differential, slot) and/or multiple arm lengths to provide efficient transfer/reception of RF energy to the air at several standard body defined frequencies. The multiple shapes form a combination of two or more independent, single-band antennas with each antenna being electrically connected to one or more of the other single-band antennas. Each single-band antenna in the combination radiates/receives dominantly at its own frequency and, practically, does not radiate/receive at another frequency. Consequently, a multiband antenna is connected to the electronics of a device at a single point and receives signals at more than one frequency. Because the principal characteristic of a multifunctional antenna is that several sections of the antenna are electrically connected to each other, different sections of the trace are designed as single-band antennas to receive/transmit at particular frequency bands that are received by the multiband antenna. For the antennas designed for a particular frequency that is received by the multiband antenna, those antennas will operate as a functional antenna to emit the frequency signal, while other sections of the trace that are not designed for that frequency will function merely as a “pass through” electric cable or conductor.

In another embodiment of a complex (Multiband and/or Diversity/MIMO System) antenna design, two or more separate sections of antennas that are not mutually connected (“subset antenna designs”) can be formed, such as subset antenna designs 106, 107 illustrated in FIG. 1, which are formed from two separate traces that are positioned relative to each other to eliminate interference, etc. A subset antenna design can be a single-band antenna that emits dominantly at a single frequency, or a multiband antenna (i.e., composed of a trace forming interconnected independent, single-band antennas). Each subset antenna design operates independently and has a separate electrical connection to the electronics of a device for receiving signals from the electronics.

The encapsulated antenna designs are functional to transmit and/or receive communication signals in at least one frequency band, and preferably across multiple frequency bands that are preferably non-contiguous bands, including at least one of the frequency ranges of about 65 MHz to about 108 MHz, and about 2.400 GHz to about 2.499 GHz. In embodiments of a simple antenna design, the antenna is designed for transmitting and/or receiving a radio signal of a specific radio frequency. In embodiments of a complex design of an antenna set, individual single-band antennas of a multiband antenna design or each subset antenna design can be designed with antenna features that are characteristic and distinctive for transmitting and/or receiving radio signals of a different and specific radio frequency band.

The present disclosure covers many different functional frequency bands and covers antennas tuned and/or matched to frequencies from 65 MHz to 50 GHz.

Embodiments of the present disclosure are applicable to antennas of 3-D shapes; antennas printed on 2-D materials that are later bent or extruded to form a 3D shape; flexible, extendable and tunable antenna designs; antennas using common, differential and slot electromagnetic modes; printed parasitic antennas (no physical electrical contact) and printed antenna reflectors; multiple printed antennas on the same device for use in diversity (spatial, polarization, or directivity diversity), MIMO and beam steering electromagnetic systems; antennas with linear and circular polarization designs/shapes; and Planar Inverted F, Inverted L, Folded Inverted Conformal, Folded J, corner reflector, parabolic dish, monopole and dipole antenna shapes and/or designs.

The invention also relates to a method of fabricating an arrangement or designs of antennas. In an embodiment of the method, an antenna design is prepared by forming an electrically conductive material on the surface of a flexible dielectric substrate to form a simple or complex antenna design. The method further includes applying a compatible dielectric material, which preferably functions as a moisture barrier, over the simple or complex antenna design to conform to and substantially match and encapsulate the antenna design on the substrate, wherein the antennas are functional to transmit and/or receive communication signals within multiple frequency bands, which are preferably non-contiguous bands.

An antenna formed according to the invention is initially formed as encapsulated conductive traces laid on a dielectric substrate (usually polymer film). As the integral part of an electronic device, this antenna can be attached to the mechanical carrier within the device so that its conductive traces remain all in one plane, or it can be attached so that its conductive traces form a simple or complex 3-dimensional shape.

The antennas formed according to the invention are intended for use as antennas supporting both primary communication with cell towers and secondary services and entertainment functions in cellular telephones and also as both primary and secondary antennas connecting different devices (other than cellular telephones) with each other or with their relevant communication hubs.

As the integral part of an operating electronic device, an antennas made according to the invention will be attached to an available surface of that device that will serve as the antenna's mechanical carrier. In that process, the dielectric substrate with the antenna thereon can be attached inside or outside of the device. In both cases, attachment can be achieved by either adhering the prefabricated antenna to a finished device or by applying a prefabricated antenna on the dielectric support using the polymer molding technology known as “in-mold decorating”.

In an embodiment of a method according to the invention, an antenna arrangement is prepared by (a) applying (e.g., printing) a liquid formulation (e.g., “conductive ink”) that is a precursor to a solid conductive material on the surface of a flexible dielectric substrate to form a simple or complex antenna design which, in some embodiments, can include a first subset antenna design, a second subset antenna design, etc.; (b) curing the liquid formulation to convert the liquid into an electrically conductive solid material to form a solid antenna design, for example, by infrared (IR) heating, inductive heating or other suitable heating process, or by ultraviolet (UV), visible or other high energy radiation, etc.; (c) applying (e.g., printing) a compatible fluid (e.g., “dielectric ink”) that is a precursor to a solid dielectric material, which is (when cured) preferably moisture impenetrable, over the solidified antenna design to conform to and substantially match the subset antenna designs; and (d) curing the precursor dielectric material such that the subset antenna designs are encapsulated between the dielectric substrate and a solid, preferably moisture impenetrable, dielectric material.

In yet another embodiment, the method comprises (a) preparing a release carrier (e.g. carrier tape) composed of a mechanical support and a releasable layer that can hold and release a pressure-sensitive adhesive (PSA); (b) preparing a flexible dielectric substrate with a suitable pressure-sensitive adhesive (PSA) coated on the “b” side; (c) applying the releasable layer of the release carrier to the pressure-sensitive adhesive (PSA) on the flexible dielectric substrate, or alternatively, laminating the flexible dielectric substrate with the PSA on its “b” side to the releasable layer of the release carrier; (d) applying (e.g., printing) a layer of a liquid formulation (e.g., “conductive ink”) that is a precursor to a solid conductive material in a desired simple or complex antenna design on the surface of the “a” side of the dielectric substrate, which in some embodiments can include a first subset antenna design, a second subset antenna design etc.; (e) curing the liquid formulation to convert the liquid into an electrically conductive solid material to form a solid antenna design; (f) applying (e.g., printing) a compatible fluid material (e.g., “dielectric ink”), which is preferably moisture impenetrable, over the antenna design to conform to and substantially match the subset antenna design; and (g) curing the precursor dielectric material to form a hardened dielectric material such that the subset antenna designs are encapsulated by the solid dielectric material.

In yet another embodiment, the method comprises (a) applying (e.g., printing) a layer of a liquid formulation (e.g., “conductive ink”) that is a precursor to a solid conductive material in a desired antenna design on the surface of the “a” side of a dielectric substrate that does not have a PSA on the “b” side, (b) curing the liquid formulation to convert the liquid into an electrically conductive solid material to form a solid antenna design; (c) applying (e.g., printing) a layer of PSA onto the antenna design to conform to and substantially match the geometry of the subset antenna designs or on a broader surface area on the dielectric substrate; (d) curing (if necessary) the PSA layer; (e) applying (e.g., laminating) a releasable layer of a release carrier (e.g. carrier tape) to the cured PSA layer; and (f) kiss cutting through the dielectric substrate but not the release carrier to remove sections not necessary for the functioning of the antennas. In some embodiments, following step (b), a “dielectric ink”, which is preferably moisture impenetrable, can be printed over the solid antenna design to conform to and substantially match the subset antenna designs, leaving openings to contacts on the conductive traces of the antenna design, and then cured to form a solid dielectric material that can encapsulate the subset antenna designs; the PSA layer can then be applied onto the dielectric material. In use, the release carrier can be peeled away from the PSA layer and the antenna design adhesively secured to an electronic device, with the dielectric substrate providing both the mechanical support and a protective cover for the printed conductive antenna during the lifetime of the device.

Thus, embodiments of the invention include a method of fabricating an antenna arrangement for use in an electronic device, the method comprising: (a) applying a releasable layer of a carrier tape to a pressure sensitive adhesive (PSA) on a “b” side of a flexible dielectric substrate; (b) applying, on an “a” side of the flexible dielectric substrate, in a single application, a suitable design of curable liquid composition including a precursor for a solid electrically conductive material; (c) curing the applied liquid precursor composition into a solid electrically conductive material functionable as two or more antennas; (d) applying a layer of a compatible liquid composition including a precursor for a solid dielectric material onto the design of antennas to conform to and substantially match said design; and (e) curing the liquid precursor composition into a solid dielectric material layer wherein the design of antennas is encapsulated between the dielectric material layer and the flexible substrate; said dielectric material layer including an opening exposing the design of antennas to provide a contact for the electronic device to connect thereto; wherein the encapsulated antennas are functional to transmit, receive, or both transmit and receive, communication signals within a frequency band. The design of antennas can comprise an assembly comprising unconnected first and second subset antennas designs positioned relative to each other on the dielectric substrate to eliminate interference upon activation of antennas within said subset designs. The assembly can comprise three or more subset antenna designs positioned relative to each other on the dielectric substrate to eliminate interference upon activation of antennas within said subset antenna designs. Preferably, the solid dielectric material is moisture impenetrable. Preferably, the dielectric material layer extends over the designs of antennas and onto the surface of the substrate. Applying the liquid compositions in steps (b) and/or (d) can comprise a printing method selected from the group consisting of silk screen printing, flexographic printing, gravure printing, stencil printing, and inkjet printing. The method can further comprise (f) kiss-cutting through the flexible dielectric substrate and PSA layer to the releasable layer of the carrier tape to outline the encapsulated antenna design(s) on said releasable layer of the carrier tape.

Another embodiment of the invention includes a method of fabricating an antenna arrangement for use in an electronic device, the method comprising: (a) applying, in a single application, a curable liquid composition comprising a precursor for a solid electrically conductive material in a design on a first “a” surface of a flexible dielectric substrate; (b) curing the design of the liquid precursor composition of step (a) to a solid electrically conductive material comprising a design of two or more functional antennas; (c) applying a layer of a compatible liquid composition comprising a precursor for a solid dielectric material onto the design of antennas to conform to and substantially match said design; (d) curing the liquid precursor composition of step (c) to a solid dielectric material layer wherein the design of antennas is encapsulated between the dielectric material layer and the flexible substrate; said dielectric material layer including an opening exposing the design of antennas to provide a contact for the electronic device to connect thereto; (e) applying a layer of a compatible pressure-sensitive adhesive (PSA) onto the dielectric material layer to conform to and substantially match the design of antennas, the PSA layer including an opening corresponding to said opening in the dielectric material layer to expose said contact; (f) optionally, curing the PSA layer; and (g) applying a releasable layer of a carrier tape to the PSA layer; the releasable layer capable of being released from contact with the PSA layer; wherein the encapsulated antennas are functional to transmit, receive, or both transmit and receive, communication signals within a frequency band. In preferred embodiments, the PSA layer extends over the dielectric material layer and onto the surface of the substrate. The method can further comprise (h) through the flexible dielectric substrate and PSA layer to the releasable layer of the carrier tape to outline the encapsulated antenna design(s) on said releasable layer of the carrier tape. In embodiments, the method can further comprise, prior to step (a), applying a releasable layer of a carrier tape to a pressure-sensitive adhesive (PSA) on a “b” side of the flexible dielectric substrate, and in step (a), applying the liquid precursor composition to an “a” side of the flexible dielectric substrate, and additionally, can further comprise (h) kiss-cutting through the carrier tape of step (g), the flexible dielectric substrate, and the PSA layer on the “b” side of the flexible dielectric substrate to outline the encapsulated antenna design(s) on the releasable layer of the carrier tape applied prior to step (a).

Another embodiment of the invention includes a method of fabricating an antenna arrangement for use in an electronic device, the method comprising: (a) applying, in a single application, a curable liquid composition comprising a precursor for a solid electrically conductive material in a design on a first “a” surface of a flexible dielectric substrate; (b) curing the design of the liquid precursor composition of step (a) to a solid electrically conductive material comprising a design of two or more functional antennas; (c) applying a layer of a compatible pressure-sensitive adhesive (PSA) onto the design of antennas to conform to and substantially match said design; the PSA layer including an opening exposing the design of antennas to provide a contact for the electronic device to connect thereto; (d) optionally, curing the PSA layer; and (e) applying a releasable layer of a carrier tape to the PSA layer; the releasable layer capable of being released from contact with the PSA layer; wherein the encapsulated antennas are functional to transmit, receive, or both transmit and receive, communication signals within a frequency band. The method can further comprise (f) kiss-cutting through the flexible dielectric substrate to outline the antennae design on the carrier tape.

Embodiments of the invention also include a laminate antenna design for use in an electronic device, comprising: a design of two or more functional antennas on an “a” side of a substrate, the antennas comprising a cured, solid electrically conductive material; a layer of a cured dielectric material overlying and substantially matching and conforming to said design of antennas, with openings in the dielectric material layer to expose the antennas to provide a contact for connection with the electronic device; a layer of a pressure sensitive adhesive (PSA) on a “b” side of the substrate; a carrier tape having a releasable layer releasably attached to the PSA layer; wherein the encapsulated antennas are functional to transmit, receive, or both transmit and receive, communication signals within a frequency band. In embodiments, the design of antennas comprises an assembly of unconnected first and second subset antenna designs positioned relative to each other to eliminate interference upon activation of antennas within said subset antenna designs. In embodiments of the laminate antenna design, the design of antennas comprises three or more subset antenna designs positioned relative to each other on the dielectric substrate to eliminate interference upon activation of antennas within said subset antenna designs. The solid dielectric material is preferably moisture impenetrable. In embodiments of the laminate antenna design, the dielectric material layer extends over the design of antennas and onto the “a” side of the substrate. The carrier tape can be in a strip form and a plurality of said laminate antenna design can be situated along a length of said carrier tape strip. In addition, the antenna design can be kiss cut through the flexible dielectric substrate and PSA layer to the releasable layer of the carrier tape to outline the encapsulated antenna design(s) on said releasable layer of the carrier tape.

In another embodiment, the laminate antenna design for use in an electronic device, comprises: a design of two or more functional antennas on an “a” side of a substrate, the antennas comprising a cured, solid electrically conductive material; a layer of a cured dielectric material overlying and substantially matching and conforming to said design of antennas, with openings in the dielectric material layer to expose the antennas to provide a contact for connection with the electronic device; a layer of a compatible pressure-sensitive adhesive (PSA) over the dielectric material layer to conform to and substantially match the design of antennas, the PSA layer including an opening corresponding to said opening in the dielectric material layer to expose said contact; and a releasable layer of a carrier tape releasably attached to the PSA layer; wherein the encapsulated antennas are functional to transmit, receive, or both transmit and receive, communication signals within a frequency band. In embodiments of the laminate antenna design, the PSA layer extends over the dielectric material layer and onto the “a” surface of the substrate. In embodiments, the antenna design is kiss cut through the flexible dielectric substrate and PSA layer to the releasable layer of the carrier tape to outline the encapsulated antenna design(s) on said releasable layer of the carrier tape. In some embodiments of the laminate antenna design, the antenna design further comprises a pressure-sensitive adhesive (PSA) on a “b” side of the flexible dielectric substrate, and a releasable layer of a carrier tape releasably attached to the pressure-sensitive adhesive (PSA) on the “b” side of the flexible dielectric substrate. In embodiments of the laminate antenna, the antenna design is kiss cut through the carrier tape attached to the PSA layer over the dielectric layer, through the flexible dielectric substrate and the PSA layer on the “b” side of the substrate, to outline the encapsulated antenna design(s) on said carrier tapes.

In another embodiment, the laminate antenna design for use in an electronic device, comprises: a design of two or more functional antennas on an “a” side of a substrate, the antennas comprising a cured, solid electrically conductive material; a layer of a compatible pressure-sensitive adhesive (PSA) overlying and substantially matching and conforming to said design of antennas, with openings in the PSA layer to expose the antennas to provide a contact for connection with the electronic device; and a releasable layer of a carrier tape releasably attached to the PSA layer; wherein the encapsulated antennas are functional to transmit, receive, or both transmit and receive, communication signals within a frequency band. In some embodiments, the antenna design is kiss cut through the flexible dielectric substrate to outline the encapsulated antenna design(s) on said carrier tape.

Other embodiments, aspects, features, objectives and advantages of the present invention will be understood and appreciated upon a full reading of the detailed description and the claims that follow.

### BRIEF DESCRIPTION OF THE DRAWINGS

Embodiments of the invention are disclosed with reference to the accompanying drawings and are for illustrative purposes only. The invention is not limited in its application to the details of construction or the arrangement of the components illustrated in the drawings. The invention is capable of other embodiments or of being practiced or carried out in various other ways. The drawings illustrate a best mode presently contemplated for carrying out the invention. In the drawings:

FIG. 1 is a diagrammatic top plan view of an embodiment of an exemplary antenna design arrangement composed of an electrically conductive material (e.g., cured “conductive” ink) on the surface of a dielectric substrate. FIG. 1A is an elevational, cross-sectional view of the substrate depicted in FIG. 1 taken along lines 1A-1A.

FIG. 2 illustrates a top plan view of the substrate of FIG. 1 at a subsequent stage showing a dielectric layer formed over the electrically conductive ink antenna design (shown in phantom). FIGS. 2A-2B are elevational, cross-sectional views of the substrate depicted in FIG. 2 taken along lines 2A-2A and 2B-2B, respectively.

FIG. 3 is a diagrammatic top plan view of another embodiment of an antenna design arrangement showing an adhesive material (shown in phantom) overlying the dielectric layer over an ink antenna design and an overlying carrier tape attached to the adhesive material. FIGS. 3A-3B are elevational, cross-sectional views of the substrate depicted in FIG. 3 taken along lines 3A-3A and 3B-3B, respectively.

FIGS. 4A-4B are elevational, cross-sectional views of another embodiment of an antenna design arrangement depicted in FIG. 3 taken along lines 3A-3A and 3B-3B, respectively, but with the addition of a releasable layer on the “b” side of the substrate and an adhesively attached carrier.

FIGS. 5-6 are elevational, cross-sectional views of the substrate of FIG. 2 taken along lines 5-5, at successive processing steps of kiss-cutting to remove unneeded sections of the dielectric substrate. FIG. 6A is a top plan view of the substrate of FIG. 6, showing the kiss-cut portions of the dielectric substrate remaining on the carrier tape.

FIG. 7 is an elevational, cross-sectional view of the substrate of FIG. 3A at an initial processing step.

FIG. 8 is a view of the substrate of FIG. 7 at a successive processing step of kiss-cutting to remove unneeded sections of the substrate. FIG. 8A is a bottom plan view of the substrate of FIG. 8 showing the kiss-cut portions of the substrate remaining on the releasable layer of the carrier tape.

FIG. 9 is an elevational, cross-sectional view of the substrate of FIG. 4A at an initial processing step.

FIG. 10 is a view of the substrate of FIG. 9 at a successive processing step of kiss-cutting to remove unneeded sections of the support. FIG. 10A is a top plan view of the substrate of FIG. 10, showing the kiss-cut portions of the carrier tape, adhesive layer and substrate (as a unit) remaining on the carrier tape that is adhesively attached to the substrate.

FIG. 11 is a flow chart illustrating steps of a method according to an embodiment of the invention as illustrated in FIGS. 1-2.

FIGS. 12-13 are flow charts illustrating alternate steps 212 of the flow chart in FIG. 11.

FIG. 14 is a flow chart illustrating steps in a process for die cutting an antenna assembly as illustrated in FIG. 2.

FIG. 15 is a top plan view of an embodiment of a carrier strip bearing multiple antenna designs as illustrated in FIG. 2.

### DETAILED DESCRIPTION OF INVENTION

Thin, flexible antenna arrangements for use in communication devices, such as mobile communication devices, are provided. Methods of making and using the antenna arrangements are also provided. The methods used to make the antenna arrangements are print-based and provide a simplified procedure with a reduced number of operations that utilizes fewer materials and produces less waste than more conventional methods based on etching and die cutting. The present disclosure pertains to both primary and secondary antennas.

The term “simple antenna design” as used herein is understood to mean a configuration of a single antenna that is functional to emit or radiate only one frequency band that is the same or different from the main radio frequency band (used for cellular network communication).

In the context of the current application, the terms, “complex antenna design” and “set of complex antenna designs” are interchangeable, and understood to mean a configuration composed of two or more antennas, each of which are structured for emitting a frequency band that is different from the main radio frequency band used for communication inside a cellular network, and different from another antenna within the design. In some embodiments, the complex antenna design is composed of a single conductive trace that forms two or more functional antenna that are interconnected within the design. In other embodiments, the complex antenna design is composed of two or more conductive traces as “antenna subsets” that are unconnected and positioned relative to each other to eliminate interference, etc. Each subset can be formed as a simple antenna design or a complex antenna design Although the antennas can be structured to radiate the same single frequency band, it is preferred that the antennas are configured and operable to radiate in different frequency bands.

One embodiment of an antenna design or arrangement according to the invention comprises a flexible substrate, a design of an electrically conductive material on a surface of that substrate which forms one or more electrically conductive portions, and a suitable and compatible, preferably moisture impermeable, dielectric material situated over and conforming to the design of the electrically conducting material, such that the electrically conductive portions are fully encapsulated (covered) by the dielectric material.

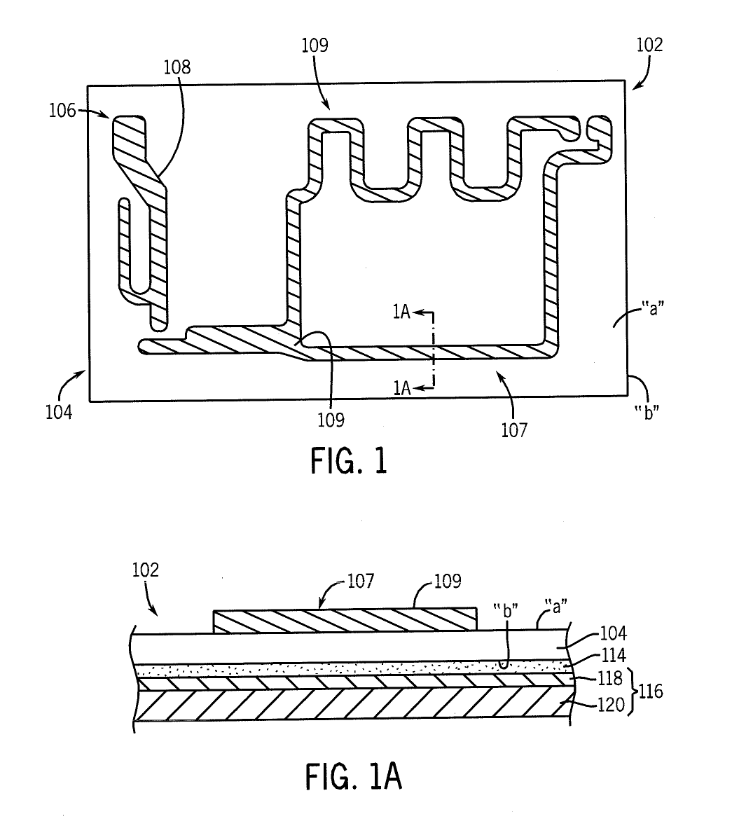

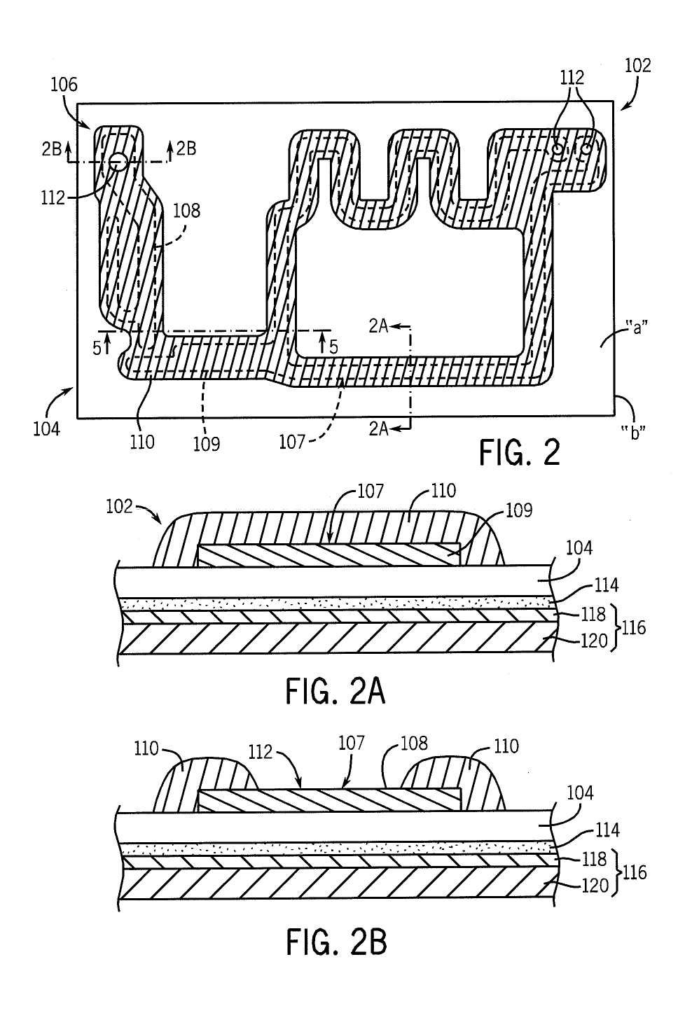

An embodiment of a complex antenna arrangement 102 in a preliminary fabrication step is depicted in FIGS. 1-1A. As illustrated, the antenna arrangement 102 includes a dielectric substrate 104 having a first surface “a” with a first antenna subset 106 and a second antenna subset 107 situated thereon. Each antenna subset 106, 107 includes an electrically conductive portion 108, 109 that is composed of an electrically conductive material. As shown in a subsequent processing step in FIGS. 2-2B, the electrically conductive portion 108, 109 is substantially encapsulated by a chemically compatible, and preferably moisture impermeable dielectric material 110. Electrical contacts 112 on the electrically conductive portions 108, 109 can be exposed through the dielectric material 110. In some embodiments as illustrated in FIG. 1A, an adhesive material 114 (such as a pressure sensitive adhesive, PSA) can be applied to the second surface “b” of the substrate 104. In some embodiments as shown in FIG. 1A, a carrier or carrier tape 116 composed of a releasable material or layer 118 on a foil or support 120 can be releasably mated with the adhesive material 114, and after necessary processing removed to expose the adhesive material 114 that can be used for securing the substrate 104 to a device component or other substrate. In use, the antenna arrangement 102 can be coupled via the contacts 112 to the electronics portion of a communication circuit of a communication device (not shown) and utilized to receive and/or transmit various communications through radio frequency signals over a range of frequencies.

The substrate 104 is composed of a thin and mechanically flexible material. The substrate can be formed from one or multiple material layers with at least the first layer “a” (onto which the conductive trace is deposited) being a dielectric material. Suitable dielectric materials include polymeric film materials, for example, polyethylene terephthalate (PET), polysulfone, polycarbonate and polyimide. A dielectric polymer can be modified by use of fillers such as ceramic or glass fillers, to modify the dielectric constant. Dielectric film materials can be treated to withstand subsequent heating during a cure of the conductive material (e.g., ink), for example, by applying pre-shrinking.

The electrically conductive material of the electrically conductive portions 108, 109 of the antennas typically comprises fine particles of conductive materials such as silver, nickel, carbon, silver coated particles of fine powder of a metallic, inorganic or organic material, nickel-coated copper, or nickel coated carbon, in suspension in a solvent and a curable carrier base mixture. In embodiments of the invention, a liquid formulation of a curable ink material comprising metal particles (e.g., “conductive ink”) is printed onto the surface “a” of the flexible dielectric substrate 104, and cured to form the electrically conductive portion 108, 109 of the antennas. The “conductive ink” is a precursor to a solid conductive material. The application of heat and prolonged exposure to the heat can increase the conductivity of the dried and cured printed antenna. Examples of commercially available, electrically conductive inks include Product 5064 available from DuPont Microelectronic Materials, CSRN 2442 available from Sun Ink, and heat curable Electrodag 050, and Electrodag 056 and UV curable Electrodag PD 054 available from Henkel Corporation. These conductive inks can be applied in a design using conventional printing methods such as silk screen, flexography, or gravure, stencil printing, inkjet or other methods known and used in the art.

As illustrated in FIG. 1, in some embodiments of the antenna design arrangement 102, the conductive ink is applied to define two or more separate antenna subsets 106, 107 on a single substrate 104. For example, a multi-band antenna arrangement can be provided that includes antenna subsets 106, 107 configured and operable to facilitate communications, respectively, of first electromagnetic signals within a first frequency band and second electromagnetic signals within a second frequency band that is distinct from the first frequency band. For example, in at least one embodiment, the first and second antenna subsets 106, 107 can provide a High Frequency antenna and a Frequency Modulation (FM) loop antenna, respectively.

The design and configuration of the antennas can vary depending on the frequency and operating characteristics. The length and shape of the electrical conductors (traces) 108, 109 are tailored to the targeted frequency range(s) for the use of the antenna. The print thickness of the traces can be altered according to the use of the antenna.

A dielectric material 110 (“dielectric ink”) that is a precursor to a solid dielectric material which (when cured) is preferably moisture impenetrable, is applied onto the solidified electrically conductive portions 108, 109 of the antennas. In some embodiments, the dielectric material 110 is applied to conform to and substantially match the design of the electrically conductive portions 108, 109 and encapsulate the antenna portions on the substrate, except for selected sites for the contacts 112, where the electrically conductive material is left exposed to allow electrical connection to the antennas.

Examples of suitable dielectric materials 110 for encapsulating the electrically conductive portions of the antenna subsets 106, 107 include dielectric polymeric materials such as liquid chemical formulations rich in aromatic, cyclic and alkyd-acrylates or urethane acrylates that, upon curing form a solid dielectric film or coating. In some embodiments, the dielectric material 110 is formed from a curable dielectric ink material that is printed over the electrically conductive material (108, 109) of the antenna subsets 106, 107, and cured to form an encapsulant layer. As shown in FIGS. 2A-2B, the dielectric encapsulant layer 110 extends beyond the edges of the electrically conductive material 108, 109 to completely encapsulate the antenna subsets 106, 107 on the substrate and match the design of the antenna subsets. Examples of suitable and commercially available “dielectric inks” include UV curable moisture resistant Electrodag PF-455 B, Electrodag PF-455BC, Electrodag 452SS and Electrodag PD 011B (all by Henkel Corporation) and UV-curable dielectric thick film formulations 5018 and 5018A (hydrophobized) by DuPont Dielectric Materials. The dielectric material 110 provides an encapsulating protective layer that is moisture impermeable, will not degrade when exposed to heat, and will not adversely affect the performance of the antennas.

As illustrated in FIG. 1A, in some embodiments, an adhesive material 114 can be applied to surface “b” of the substrate 104, for example, by printing or by coating using an applicator such as, a doctor blade, a roll coater, etc., for adhesively securing the substrate 104 of the antenna arrangement 102 to another substrate such as a support, a carrier or a device component, for example, a component of a mobile communications device. In preferred embodiments, the adhesive material is a pressure-sensitive adhesive (PSA), although other types of adhesives can be used.

In some embodiments as shown in FIG. 1A, a carrier tape 116 can be applied to the adhesive material 114 as a temporary and releasable substrate prior to securing the antenna arrangement 102 to a final working location in a communication device. A carrier tape 116 is generally composed of a releasable layer 118 (e.g., wax, silicone, fluoropolymer, etc.) on a support 120, which may be, for example, a polymeric film (e.g., polyester, polyethylene terephthalate, polypropylene, polystyrene, or polyethylene), metal foil, paper tape or other suitable material. The releasable layer 118 (e.g., liner or coating) allows the carrier tape 116 to be releasably secured to the adhesive material 114. The carrier tape 116 can be subsequently removed (e.g., peeled off) to expose the adhesive material 114 for securing the substrate 104 of the antenna arrangement 102 to an electronic device or component of a device such as a mobile electronic communication device, a measurement device or a monitoring device, or other substrate. In other embodiments, the substrate 104 bearing an adhesive material 114 on surface “b” (without the carrier 116) can be directly applied to a device or other substrate. As the integral part of an electronic device, this antenna can be attached to the available solid surface in the device that will serve as its mechanical carrier. In such cases, the dielectric substrate 104 carrying the antenna can be attached inside the device or on its outside surface. The attachment can be made by either adhering the prefabricated antenna to a finished device using the PSA 114 on the “b” side of the dielectric substrate 104 or by inserting the antenna situated on the dielectric support 104 using a polymer molding technology known as “in-mold decorating.”

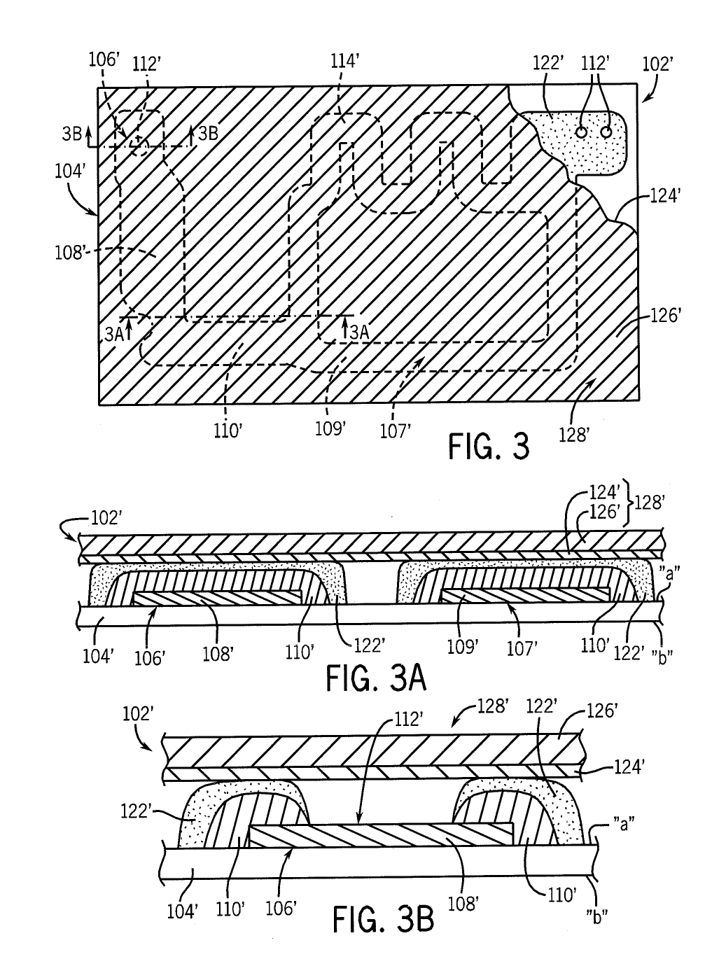

Referring to FIGS. 3 and 3A-3B, in another embodiment of an antenna arrangement 102′, an adhesive material 122′ can be applied as a layer over and to extend beyond the edges of the cured dielectric material 110′ (over the electrically conductive portions 108′, 109′) on the “a” side of the substrate 104′ to match the design of the antenna subsets. The releasable layer 124′ on a support 126′ of a carrier tape 128′ can be applied to the adhesive material 122′, and later removed such that the printed antenna, composed of the conductive trace 108′ and the dielectric layer 110′ can be adhesively secured by the adhesive material 122′ to a device or device component or any other substrate. In another embodiment (not illustrated), the dielectric material layer 110′ can be eliminated and the adhesive material 112′ applied as a layer directly onto the electrically conductive portions 108′, 109′ to encapsulate and extend beyond the edges of the conductive portions 108′, 109′.

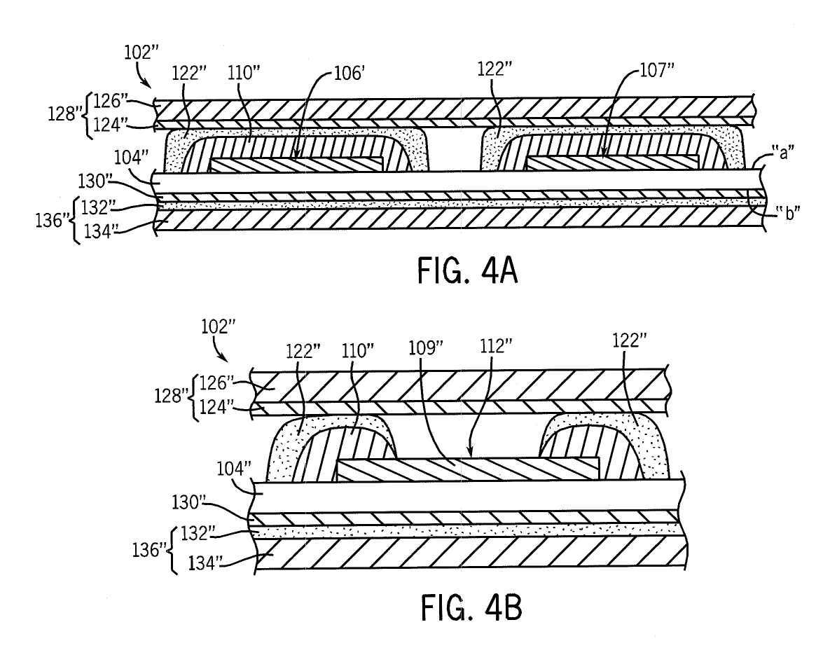

In other embodiments as illustrated in FIGS. 4A-4B, the “b” side of the substrate 104″ can bear a layer 130″ of a material that will releasably attach to an adhesive (PSA) material 132″ on a carrier 134″ of a carrier tape 136″. In that embodiment, the carrier tape 136″ can be removed by separating the adhesive material layer 132″ from the releasable layer 130″ on the “b” side of the substrate 104″, the adhesive layer 132″ having a stronger bond with the carrier 134″ than with the releasable layer 130″.

The antenna assemblies can then be kiss-cut to separate the printed antenna design from the non-printed portions of the substrate.

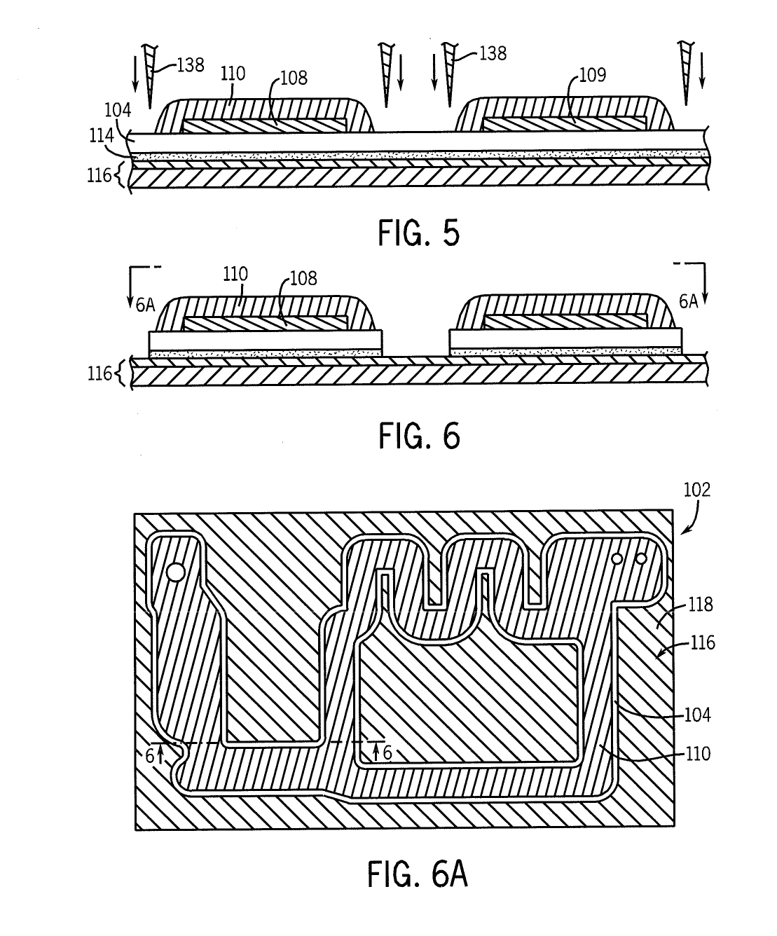

In an embodiment of die cutting the antenna assembly 102 depicted in FIG. 2, the assembly can be die cut (kiss-cut) by positioning blades 138 as illustrated in FIG. 5, to cut through the dielectric substrate 104 and the adhesive layer (PSA) 114 but not through the carrier tape 116. As shown in FIGS. 6-6A, these cuts separate the non-printed parts of the dielectric substrate 104 and the attached adhesive 114 from the portions of the dielectric substrate 104 that carry the electrically conductive portions 108, 109 and the encapsulating dielectric layer 110. In this case, the printed antenna 108, 109 is covered only by the dielectric coating 110 and it can be attached to a functional electronic device by applying the adhesive layer (PSA) 114 on the dielectric substrate 104. To install the antenna assembly 102 into a device, the assembly can be peeled off of the carrier tape 116 to expose the adhesive (PSA) layer 114 on the substrate 104, which can then be adhesively applied to a surface of the electronic device or component.

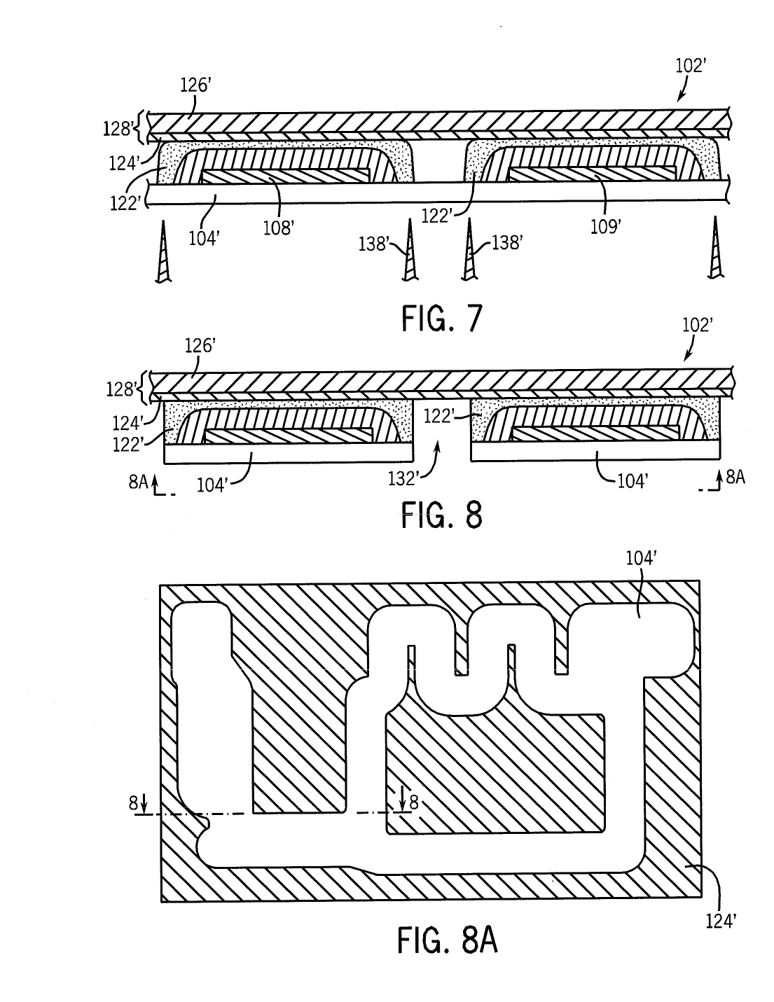

Referring to FIG. 7, in an embodiment of die cutting (kiss cutting) the antenna assembly 102′ depicted in FIG. 3, blades 138′ can be positioned as shown to cut through the dielectric substrate 104′ and adhesive material 122′ but not the carrier tape 128′. As illustrated in FIGS. 8-8A, the cuts separate the printed from the non-printed portions of the dielectric substrate 104′. The antenna assembly 102′ can be installed by removing the carrier tape 128′ from the adhesive material layer 112′ and attaching the adhesive 122 to a device surface. In this embodiment, the dielectric material layer 110′ is optional and the adhesive material 112′ can be directly applied to encapsulate the electrically conductive portions 108′, 109′. The adhesive material 122′ is substantially wider than the conductive material (trace) 108′, 109′, the adhesive material 122′ providing adhesion of the antenna to the selected part of the electronic device and the dielectric substrate 104 provides the mechanical protection and a water barrier to the conductive trace 108′, 109′. With this arrangement, the antennas are positioned closer to the solid substrate of the electronic device.

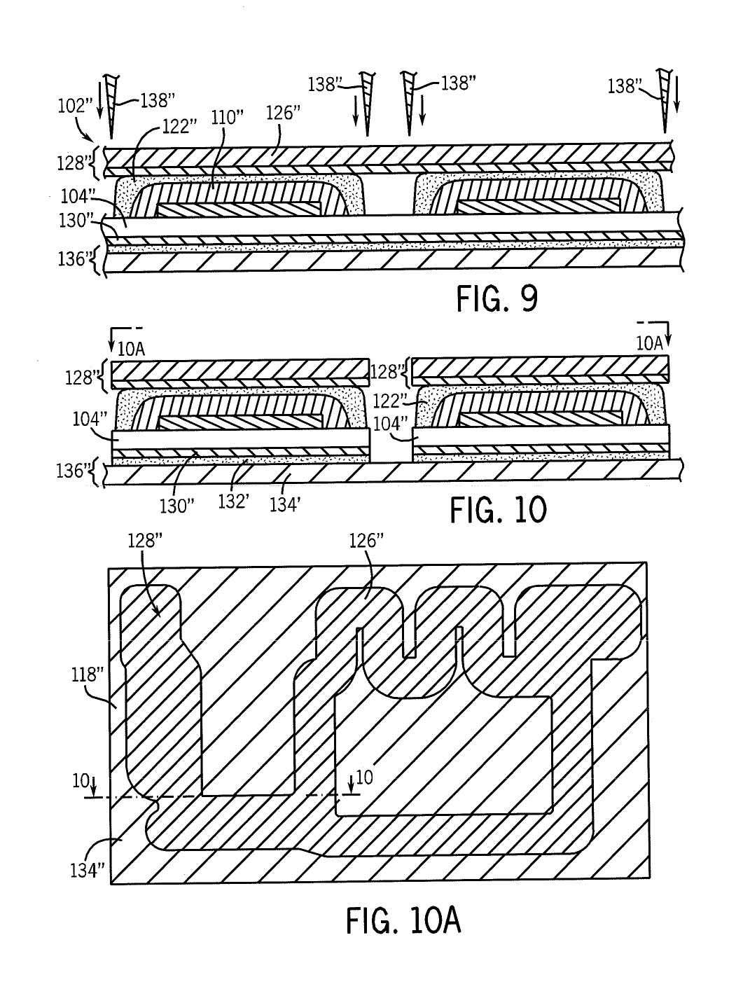

FIG. 9 illustrates an embodiment of die cutting the antenna assembly 102″ depicted in FIG. 4A. As depicted, blades 138″ can be positioned to cut through the carrier tape 128″, the dielectric substrate 104″ and releasable layer 130″ (on the “b” side of the substrate 104″) but not through the adhesive layer 132″ or carrier 134″ of the carrier tape 136″, resulting in the structure shown in FIGS. 10-10A. To install the antenna assembly 102″, the adhesive layer 132″ is separated (peeled off) from the releasable layer 130″ on the “b” side of the substrate, and the carrier tape 136″ is then separated from the substrate 104″. The antenna arrangement 102″ can be attached by the adhesive layer 122″ to the electronic device, the dielectric substrate 104″ functioning as a covering for the antennas. In this embodiment, the dielectric material layer 110″ is optional and the adhesive material 112″ can be directly applied to encapsulate the electrically conductive portions 108″, 109″.

The antenna arrangements can be incorporated into a variety of mobile electronic communication or measurement or monitoring devices, including mobile communication devices such as cellular phones, wireless electronic book (e-book) readers (e.g., Amazon Kindle, Sony Reader, Barnes & Noble Nook, etc.), personal digital assistants (PDAs), Global Positioning Systems (GPS), and other devices such as: including but not limited to, medical equipment and patient monitoring devices, office equipment, electronic meeting communication devices, entertainment devices, manufacturing machinery, automobile and truck functions monitoring devices, home and restaurants appliances, electric and gas distribution and metering devices, gambling machinery and equipments such as chips and playing card and livestock monitoring devices, which operate through antenna by means of a wireless telecommunications network implemented with a remote information transmission system that uses electromagnetic waves, such as radio waves, for the carrier.

In these devices, the antenna arrangements can be coupled to the transmitting and/or receiving circuitry of the device to provide an operative communication device capable of transmitting and/or receiving signals in one or more frequency bands. Examples of band frequencies that can be transmitted and/or received by the conductive portions of the present antenna arrangements when the antenna arrangements are coupled to the transmitting and/or receiving circuitry of a mobile device, include, frequency modulation (FM) band frequencies of about 65.8-74 MHz, about 76-90 MHz, and about 87.5-108 MHz (i.e., frequencies in the range of about 65 MHz to 108 MHz), Bluetooth radio frequencies (2.4 GHz), WLAN/Wi-Fi frequencies of about 2.400-2.499 GHz, and/or global positioning system (GPS) frequencies of about 1176 MHz to 2228 MHz. The antennas formed according to the invention are primarily intended for use as antennas supporting secondary services and entertainment functions in cellular telephones and not for primary communication with cell towers but also as both primary and secondary antennas connecting different non-cellular telephone devices with each other or with their relevant communication hubs.

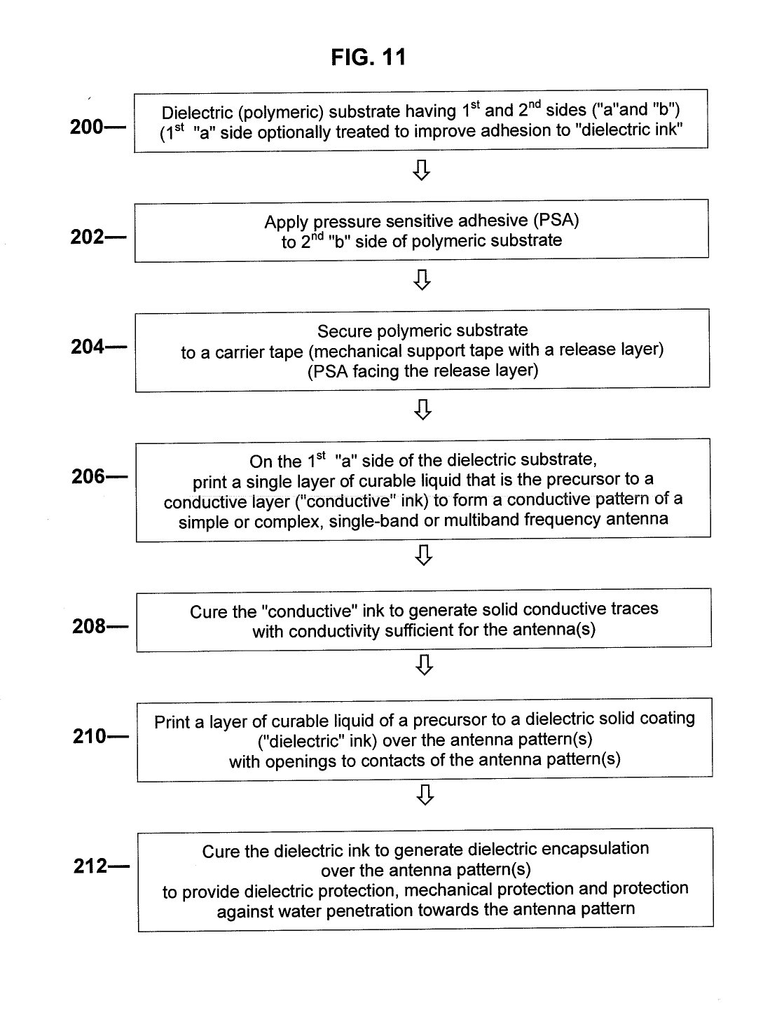

FIG. 11 is a process flow of an embodiment of a method of fabricating an antenna arrangement 102 according to the invention, with reference to FIGS. 1-2.

Beginning at step 200, a substrate 104 is provided that includes a first side/surface (“a”) and a second side (“b”), and is sized and configured according to the application and to support the selected antenna design. In the illustrated embodiment, the substrate is composed of a dielectric (polymeric) material that can be optionally treated to modify the surface on the “a” side to improve adhesion to a dielectric ink. The thickness of the substrate can range from about 12 μm to about 250 μm, preferably from about 50 μm to about 125 μm.

At step 202, a pressure sensitive adhesive (PSA) 114 is applied, for example, by coating or spraying, onto the second (“b”) side of the substrate 104. The thickness of the PSA can range from about 25 μm to about 250 μm.

At step 204, a carrier tape 116 composed of a mechanical support tape 120 with an attached releasable layer 118 is secured to the adhesive layer 114 on the “b” side of the dielectric substrate 104, with the adhesive (PSA) layer facing the releasable layer.

At step 206, a single layer of a curable liquid that is a precursor to a solid conductive material layer (“conductive ink”) is printed on the first (“a”) side of the dielectric substrate 104 to form the conductive design of a simple or complex, single or multi-frequency, antenna design, illustrated as electrically conductive portions 108, 109 that form the antenna subset designs 106, 107. According to the invention, only one layer of a conductive ink precursor material is printed. Within the same design, the printing can be a single complex design of lines and geometric shapes or, in other embodiments, two or more antenna designs that are not mutually connected. All of the designs are printed in a single deposition of the liquid precursor for the hardened conductive material (“conductive ink”).

Conductive inks for printing the conductive portions 108, 109 are known in the art and typically include a curable base liquid and either carbon or silver particles, although other conductive particles are suitable to provide the conductive properties. Printing of the electrically conductive ink can be according to conventional methods, including, for example, screen printing, stencils, gravure, pad and flexographic printing. Depending on the printing method and desired ink thickness, a single or multiple passes of ink application can be used to form the electrically conductive portions 108, 109. The electrically conductive material should be sufficiently thick to provide an operatively conductive trace upon curing the ink. The thickness of the electrically conductive material typically ranges from about 5 μm to about 30 μm, and more typically from about 8 μm to about 20 μm The selection of a specific electrically conductive ink and thickness of the electrically conductive portions can be varied according to the intended use and application of the antenna arrangement 102.

At a next step 208, the “conductive” ink is adequately cured by a suitable means, for example, by heat curing, UV radiation curing or electron beam curing, to generate the solid electrically conductive traces 108, 109 having conductivity sufficient for functioning of the antenna(s).

At step 210, a layer of a curable liquid 110 that is a precursor to a dielectric solid coating (“dielectric” ink) is formed (e.g., printed) over the cured conductive traces 108, 109 and the dielectric substrate 104 adjacent the traces to encapsulate the traces 108, 109, as illustrated in FIG. 2. Curable dielectric inks for forming an encapsulating material that is moisture and humidity resistant are known in the art and commercially available. The dielectric ink can be applied as a layer by using the same or similar techniques as used with the conductive ink (e.g., screen printing, stencils, etc.). The thickness and width of the dielectric ink layer 110 should be sufficient to encapsulate the conductive traces 108, 109 on the substrate. Typically, the thickness of the dielectric ink layer 100 ranges from about 10 μm to about 50 μm, and more typically from about 20 μm to about 40 μm. In some embodiments, the dielectric ink 110 can be printed to substantially match or conform to the designs of the electrically conductive portions (traces) 108, 109, as illustrated in FIG. 2.

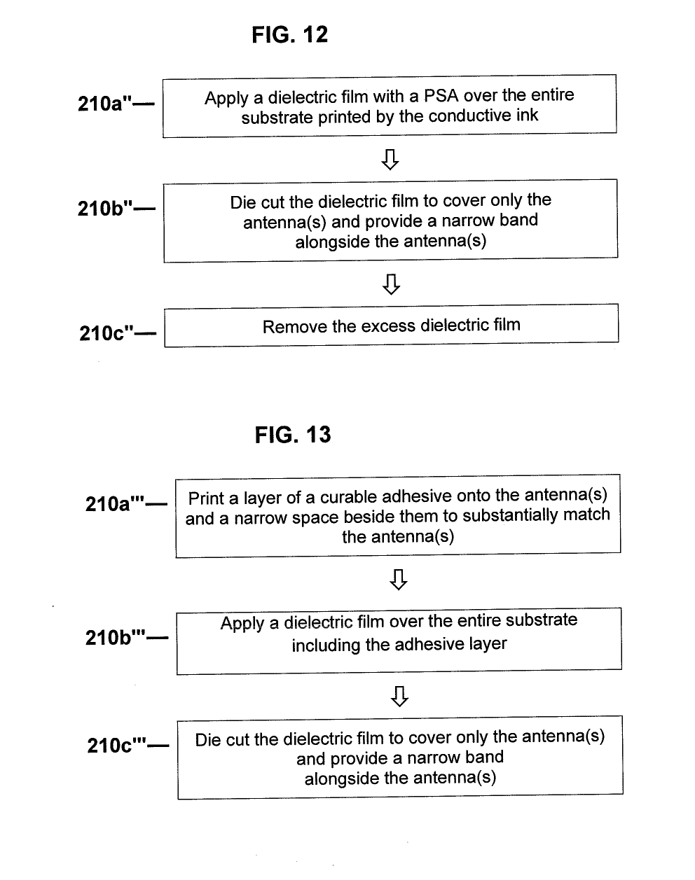

In other embodiments, as illustrated in FIG. 12, in a step 210a″, a dielectric film 110 bearing a PSA material on a surface can be initially applied in a step 210a″ to substantially cover the entire surface “a” of the dielectric substrate 104 including the cured, solid conductive ink portions 108, 109 (PSA side facing the substrate 104). Then in a step 210b″, the dielectric film 110 can be die cut to cover only the conductive portions 108, 109 that form the antennas and extend as a narrow strip beyond the edge of the conductive portions, as depicted in FIG. 2. Excess of the dielectric film 110 can then be removed (step 210c″).

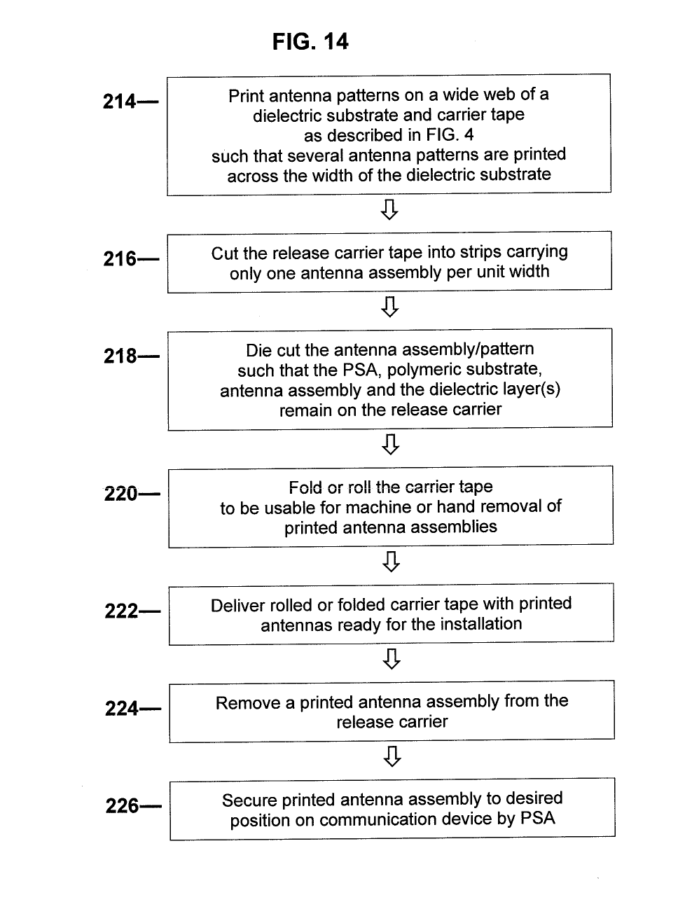

In yet another embodiment illustrated in FIG. 13, in a step 210a′″, a layer of a curable adhesive 114 can be initially printed onto the cured conductive ink portions 108, 109 (i.e., the antennas) and as a contiguous, narrow strip alongside the conductive ink portions to substantially match the designs of the electrically conductive portions 108, 109. In a subsequent step 210b′″, a dielectric film 110 can be applied over the entire substrate, including the adhesive layer 114. Then, in a step 210c′″, the dielectric film 110 can be die cut to cover only the conductive ink portions 108, 109 (i.e., the antennas) and the adjacent contiguous strip so as to encapsulate the conductive ink portions and substantially match the designs of the electrically conductive portions 108, 109.

As depicted in FIG. 2, electric contacts 112 can be provided, for example, by avoiding printing the dielectric ink onto the designated contact spots (e.g., by masking or selectively printing) or selectively removing the dielectric ink or layer 110 to expose the contact points. The contacts 112 can be used for selectively coupling the first and second antenna subsets 106, 107 to an electrical contact to of the electronic device, such as the internal circuit of a mobile device. In the illustrated embodiment in FIG. 2, three electrical contacts 112 have been provided, with one contact on the electrically conductive portion 108 of the first antenna subset 106 and a pair of contacts 112 on the electrically conductive portion 109 of the second antenna subset 108.

In a step 212, the dielectric ink is then cured to generate dielectric encapsulation over the antenna design(s) to provide dielectric protection, mechanical protection and protection against water penetration towards the antenna design.

Upon completion, the antenna assembly/design 102 can be then be die cut.

For example, referring to FIG. 14, in a step 214, an antenna assembly/design can be printed on a dielectric substrate as described with reference to FIG. 4, but printed on a wide web of the dielectric support 104 and carrier tape such that several antenna designs are printed across the width of the dielectric substrate. Then upon completion, in a step 216, the antenna assembly/design 102 can then be die cut (kiss cut) such that the polymeric substrate 104, the antenna portions (traces) 106, 107, the dielectric layer 110 and the adhesive layer 114 remain on the carrier tape 116, as shown in FIG. 6.

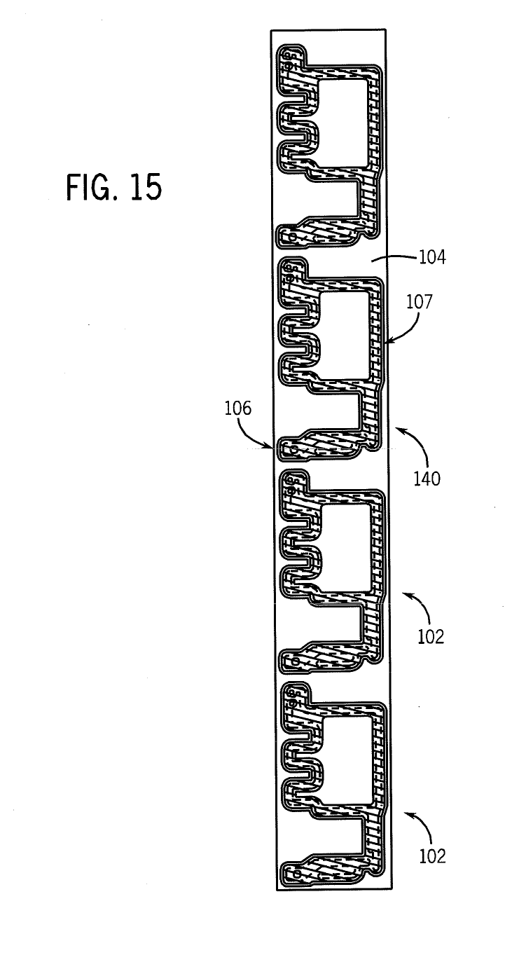

In a step 218, the substrate 102 and carrier tape 116 can be cut into strips 140 having a length and width, which supports a plurality of antenna assemblies 102 extending the length but only a single antenna design 102 per unit width, as illustrated in FIG. 15.

In a step 220, the carrier tape strip 140 can be folded or rolled for storage.

In a step 222, the rolled or folded carrier tape strip 140 can be delivered for use and installation.

In a step 224, the individual printed antenna assemblies 102 can be removed from the carrier tape strip 140 by machine or manual removal.

In a final step 226, the printed antenna assembly 102 can be secured by means of the PSA material at a desired position in or on a communication device, including connecting the exposed contacts 112 to contacts on the electrical device.

The invention will be further described by reference to the following example. This example is not meant to limit the scope of the invention that has been set forth in the foregoing description. Variation within the concepts of the invention are apparent to those skilled in the art.

### Example

Present metal foil antennas, both etched in a flexible PCB or die-cut, are often covered with an insulative film or coating to prevent scratching and tearing of the metal foil. The thin insulative film is glued onto the metal foil and is chosen to meet mechanical requirements, not electrical requirements. The insulative film covers the entire antenna, often resulting in a high loss tangent.

In the present example, two commercially available cellular telephones were tested for the radiation efficiency of their secondary antennas. One telephone was tested only at FM (88-103 MHz) frequencies and the other telephone was tested at FM, Global Positioning Satellite (1.575 GHz) and Bluetooth (2.4 GHz) frequencies. In both cases, tests were made with antennas manufactured by screen printing conductive ink consisting of dispersed silver particles in a polymeric binder on dielectric film substrate. In one case, the printed antennas were left uncovered and in the other case, the printed antennas were coated with a high dielectric constant material.

It was unexpectedly discovered that when the dielectric material was coated onto the same side of the antenna as the ground plane (which is the populated printed circuit board of the electronic device), the amount of RF power radiated by the antenna increased. When the dielectric coating was placed on the side of the antenna opposite from the ground plane, the amount of RF power radiated by the antenna decreased.

Although not intended to limit the disclosure, an explanation for this observation is that electromagnetic radiant energy of the antenna was reflected from the dielectric boundaries (the boundary between the high dielectric constant coating and air). When the antenna impedance approaches 377 ohms (impedance of free space), RF energy radiates off the conductive ink into the high dielectric coating.

In the case in which the dielectric coating is situated between antenna and the PC board ground plane, some RF energy radiated by the antenna is reflected at the dielectric boundary between the dielectric coating and air and it does not reach the ohmic-resistive ground plane. Thus, less RF energy is dissipated in the ground plane as heat.

However, when the antenna is positioned inbetween the dielectric coating and the ground plane, more of the antenna-radiated RF energy is directed toward the ground plane and more of the RF energy becomes dissipated as heat. This effect was evidenced at both FM and Bluetooth frequencies and was thus frequency independent.

The phenomenon of the reflection of RF signals from the boundary of two materials with different dielectric constants is analogue to the phenomenon which happens with the light which reflects internally from the boundary between light transmitting material with high refractive index (dielectric constant) and light transmitting material with low refractive index (low dielectric constant). In modern fiber optics, the structure of the fibers is such that the core of the fiber always has a high dielectric constant and the shell has the low dielectric constant so two touching high dielectric fibers always had a low dielectric boundary between them.

The Example illustrated controlled directing of antenna radiant energy to free space from 50 MHz to 100 GHz utilizing a printed or adhered dielectric compound on an antenna surfaces. The dielectric material layer does not need to cover the entire antenna.

Table 1 below illustrates Average Power Results for FM Radiation Vertical Mount Horizon Cut. The acronym “dBi” refers to dB Isotropic calibration. The Type #1 phone was measured at 90 MHz and the Type #2 phone was measured at 102 MHz. The dielectric coating used was Henkel Electrodag 452 SS.

TABLE 1

| | Phone | | | |
|---|---|---|---|---|
| | Commercial | Commercial | Commercial | Commercial |
| | type # 2 | type # 2 | type # 2 | type # 1 |
| Dielectric coating | Between | Between | Between | On outward |
| | antenna and | antenna and | antenna and | facing side of |
| | ground plane | ground plane | ground plane | antenna |
| Antenna test signal | Matched printed | Matched printed | Printed antenna | Matched printed |
| source | antenna | antenna | driven by | antenna |
| | connected to a | connected to a | unmodified | connected to a |
| | signal generator | signal generator | phone | signal generator |
| | through a | through a | manufacturer's | through a coaxial |
| | coaxial cable | coaxial cable | internal FM | cable |
| | | | signal source. | |
| Manufacturer's metal | Reference | Reference | Reference | Reference |
| foil antenna average | (−48.9 dBi) | (−48.9 dBi) | (−56.5 dBi) | (−57.8 dBi) |
| radiated power in | | | | |
| vertical mount horizon | | | | |
| cut | | | | |
| Ink Type | Custom | Henkel | Dupont | Dupont |
| | formulated | formulated | formulated | formulated silver |
| | silver | silver | silver | |
| Ink antenna without | (−51.5 dBi) | (−50.4 dBi) | No Data Taken | (−58.2 dBi) |
| dielectric coating | | | | |
| radiated power | | | | |
| Ink antenna and | (−51.0 dBi) | (−49.7 dBi) | (−57.1 dBi) | (−59.5 dBi) |
| dielectric coating | | | | |
| radiated power | | | | |
| Radiated power increase | 0.5 dBi | 0.7 dBi | NA | (−1.3 dBi) |
| (loss) due to dielectric | | | | |
| coating | | | | |

Table 2 below provides GPS Radiation 3D Efficiency Results. The maximum efficiency measured in GPS band (1570-1580 MHz) is shown. The dielectric coating used was Henkel Electrodag 452 SS.

TABLE 2

| | Phone | |
|---|---|---|
| | Commercial | Commercial |
| | type # 2 | type # 2 |
| Dielectric coating on antenna | Yes | Yes |
| located between antenna and | | |
| ground plane? | | |
| Antenna test signal source | Matched printed | Matched printed |
| | antenna connected | antenna connected |
| | to a signal | to a signal |
| | generator through a | generator through a |
| | coaxial cable | coaxial cable |
| Manufacturer's (metal foil | 13.18 | 13.18 |
| with protective film) antenna | | |
| efficiency % | | |
| Manufacturer's antenna | 15.58 | 15.58 |
| without protective film | | |
| efficiency % | | |
| Ink type | Dupont formulated | Custom formulated |
| | silver | silver |
| Ink antenna and dielectric | 27.33 | 14.74 |
| coating radiated efficiency % | | |

Table 3 below provides BT Radiation 3D Efficiency Results. The maximum efficiency measured in Bluetooth band (2400-2483 MHz) is shown. The dielectric coating used was Henkel Electrodag 452 SS.

TABLE 3

| | Phone | |
|---|---|---|
| | Commercial | Commercial |
| | type # 2 | type # 2 |
| Dielectric coating on | Yes | Yes |
| antenna located between | | |
| antenna and ground plane? | | |
| Antenna test signal source | Matched printed | Matched printed |
| | antenna connected | antenna connected |
| | to a signal | to a signal |
| | generator through | generator through |
| | a coaxial cable | a coaxial cable |
| Manufacturer's (metal foil | 11.01 | 11.01 |
| with protective film) | | |
| antenna efficiency % | | |
| Manufacturer's antenna | 15.53 | 15.53 |
| without protective film | | |
| efficiency % | | |
| Ink type | Dupont formulated | Custom formulated |
| | silver | silver |
| Ink antenna without | 10.27 | No Data Taken |
| dielectric coating radiated | | |
| efficiency % | | |
| Ink antenna and dielectric | 14.14 | 12.23 |
| coating radiated efficiency % | | |
| Radiated efficiency increase | 3.87 | NA |
| (loss) due to dielectric | | |
| coating | | |

The approach utilized in this Example met both mechanical scratch resistance and optimized antenna radiation efficiency for the available space volume. It required the use of a dielectric material with low loss tangent and high dielectric constant (greater that 2). The application of printed dielectrics in the present examples provided both mechanical and electrical advantages.

It is specifically intended that the present invention not be limited to the embodiments and illustrations contained herein, but include modified forms of those embodiments including portions of the embodiments and combinations of elements of different embodiments as come within the scope of the following claims.

What is claimed is:

1. A method of fabricating an antenna arrangement for use in an electronic device, the method comprising:
(a) applying on an “a” side of a flexible dielectric substrate in a single application, a design of a curable liquid composition comprising a precursor for a solid electrically conductive material;
(b) curing the design of the liquid precursor composition into a solid electrically conductive material comprising a design of two or more functionable antennas;
(c) applying one of:
(i) a layer of a compatible liquid composition comprising a precursor for a solid dielectric material onto the design of antennas to conform to and substantially match said design; and
curing the liquid precursor composition into a solid dielectric material layer wherein the design of antennas is encapsulated between the dielectric material layer and the flexible substrate; said dielectric material layer including an opening exposing the design of antennas to provide a contact for the electronic device to connect thereto; or
(ii) a layer of a compatible pressure-sensitive adhesive (PSA) onto the design of antennas to conform to and substantially match the design of antennas, the PSA layer including an opening exposing the design of antennas to provide a contact for the electronic device to connect thereto;
optionally, curing the PSA layer; and
applying a releasable layer of a carrier tape to the PSA layer; the releasable layer capable of being released from contact with the PSA layer; and
(d) optionally applying a releasable layer of a carrier tape to a pressure sensitive adhesive (PSA) on a “b” side of the flexible dielectric substrate;
wherein the encapsulated antennas are functional to transmit, receive, or both transmit and receive, communication signals within a frequency band.

2. The method of claim 1, wherein the design of antennas comprises an assembly comprising unconnected first and second subset antennas designs positioned relative to each other on the dielectric substrate to eliminate interference upon activation of antennas within said subset designs.

3. The method of claim 2, wherein the assembly comprises three or more subset antenna designs positioned relative to each other on the dielectric substrate to eliminate interference upon activation of antennas within said subset antenna designs.

4. The method of claim 1, wherein the solid dielectric material is moisture impenetrable.

5. The method of claim 1, wherein the solid dielectric material layer of step (c)(i) or the PSA layer of step (c)(ii) extends over the designs of antennas and onto the surface of the substrate.

6. The method of claim 1, further comprising, after step (c)(i):
applying a layer of a compatible pressure-sensitive adhesive (PSA) onto the solid dielectric material layer of step (c)(i) to conform to and substantially match the design of antennas, the PSA layer including an opening corresponding to said opening in the dielectric material layer to expose said contact;
optionally, curing the PSA layer; and
applying a releasable layer of a carrier tape to the PSA layer; the releasable layer capable of being released from contact with the PSA layer.

7. The method of claim 1, wherein applying the liquid composition in step (a) or step (c)(ii) comprises a printing method selected from the group consisting of silk screen printing, flexographic printing, gravure printing, stencil printing, and inkjet printing.

8. The method of claim 1, further comprising:
(e) kiss-cutting through the flexible dielectric substrate and the PSA layer of step (d) on the “b” side, the PSA layer of step (c)(ii) overlying the dielectric layer, or both, to the releasable layer of the carrier tape to outline the encapsulated antenna design(s) on said releasable layer of the carrier tape.

9. A laminate antenna design for use in an electronic device, comprising:
a design of two or more functional antennas on an “a” side of a substrate, the antennas comprising a cured, solid electrically conductive material;
a layer of a cured, solid dielectric material overlying and substantially matching and conforming to said design of antennas, with openings in the dielectric material layer to expose the antennas to provide a contact for connection with the electronic device; and
at least one of:
(a) a layer of a pressure sensitive adhesive (PSA) on a “b” side of the substrate, and a carrier tape having a releasable layer releasably attached to the PSA layer; or
(b) a layer of a compatible pressure-sensitive adhesive (PSA) over the dielectric material layer to conform to and substantially match the design of antennas, the PSA layer including an opening corresponding to said opening in the dielectric material layer to expose said contact, and a releasable layer of a carrier tape releasably attached to the PSA layer;
wherein the encapsulated antennas are functional to transmit, receive, or both transmit and receive, communication signals within a frequency band.

10. The laminate antenna design of claim 9, wherein the design of antennas comprises an assembly of unconnected first and second subset antenna designs positioned relative to each other to eliminate interference upon activation of antennas within said subset antenna designs.

11. The laminate antenna design of claim 10, wherein the design of antennas comprises three or more subset antenna designs positioned relative to each other on the dielectric substrate to eliminate interference upon activation of antennas within said subset antenna designs.

12. The laminate antenna design of claim 9, wherein the solid dielectric material layer or the PSA layer (b) extends over the design of antennas and onto the “a” side of the substrate.

13. The laminate antenna design of claim 9, wherein the carrier tape is in a strip form and a plurality of said laminate antenna design are situated along a length of said carrier tape strip.

14. The laminate antenna design of claim 9, wherein the antenna design is kiss cut through the flexible dielectric substrate and the PSA layer (a) on the “b” side of the substrate, the PSA layer (b), or both, to the releasable layer of the carrier tape to outline the encapsulated antenna design(s) on said releasable layer of the carrier tape.

15. The laminate antenna design of claim 9, wherein the antenna design is kiss cut through the carrier tape attached to the PSA layer (b) over the dielectric layer, through the flexible dielectric substrate and the PSA layer on the “b” side of the substrate, to outline the encapsulated antenna design(s) on said carrier tapes.

16. The laminate antenna design of claim 9 mounted in an electronic device wherein the encapsulated antennas are functional to transmit, receive, or both transmit and receive, communication signals within a frequency band.

17. The laminate antenna design of claim 16, wherein the laminate antenna design is mounted in the electronic device such that the dielectric material layer overlying the antennas is situated between the antennas and a ground plane of the electronic device.

18. A laminate antenna design for use in an electronic device, comprising:
a design of two or more functional antennas on an “a” side of a substrate, the antennas comprising a cured, solid electrically conductive material;
a layer of a compatible pressure-sensitive adhesive (PSA) overlying and substantially matching and conforming to said design of antennas, with openings in the PSA layer to expose the antennas to provide a contact for connection with the electronic device; and
a releasable layer of a carrier tape releasably attached to the PSA layer;
wherein the encapsulated antennas are functional to transmit, receive, or both transmit and receive, communication signals within a frequency band.

19. The laminate antenna design of claim 18, wherein the antenna design is kiss cut through the flexible dielectric substrate to outline the encapsulated antenna design(s) on said carrier tape.

20. The laminate antenna design of claim 18, mounted in an electronic device wherein the encapsulated antennas are functional to transmit, receive, or both transmit and receive, communication signals within a frequency band.

21. The laminate antenna design of claim 20, wherein the laminate antenna design is mounted in the electronic device such that the dielectric material layer overlying the antennas is situated between the antennas and a ground plane of the electronic device.
